(19) United States
(12) Patent Application Publication
(10) Pub. No.: US 2010/0178551 A1
(43) Pub. Date: Jul. 15, 2010

(54) Galvanic Element, and Methods for the Production of Galvanic Elements

(76) Inventor: Andre Kreutzer, Mittweida (DE)

Correspondence Address: GUDRUN E. HUCKETT DRAUDT, SCHUBERTSTR. 15A, WUPPERTAL, 42289, DE

(21) Appl. No.: 12/377,140

(22) PCT Filed: Aug. 11, 2007
(86) PCT No.: PCT/DE07/01431

§ 371 Date: Feb. 11, 2009

(30) Foreign Application Priority Data
Aug. 11, 2006 (DE) 10 2006 038 362.1

(51) Int. Cl. H01M 6/12; H01M 2/14

(52) U.S. Cl. 429/162; 29/623.1

(57) ABSTRACT

The invention relates to galvanic elements comprising two electrodes on at least one support and at least one electrolyte in at least some areas between the electrodes. Also disclosed are methods for producing galvanic elements. Said galvanic elements comprising at least one support, two electrodes, and at least one electrolyte in at least some areas between the electrodes as well as the methods for producing galvanic elements are characterized particularly by the simple structure thereof and can be produced economically. For this purpose, at least one area of a plate-shaped body encompassing introduced openings is disposed between the electrodes as a separator. Alternatively, at least one area of a layer or of an object that is used as a receptacle can be disposed between the electrodes, subareas of the support, or one of the electrodes and a subarea of the support. The support comprising the electrodes is tilted, folded, seamed, bent, or turned over in such a way that the electrodes point in the direction of the and the electrolyte.

The invention relates to galvanic elements with at least one substrate and two electrodes as well as at least one electrolyte at least in some areas between the electrodes, and methods of producing galvanic elements.

Flat galvanic elements in sandwich design without a separator that have a fixed electrolyte are, for example, known from U.S. 2004/0209160.

Galvanic elements equipped with separators are known, for example, from U.S. Pat. Nos. 5,652,043; 5,811,204; 2003/0059673, and 2004/0175624. The materials used as separators are absorbent materials with micropores such as paper. The substrates that carry the electrodes and the separator consist of various materials. An absorbent and porous material is not suitable as a substrate for the electrodes and thus a fully enclosed system.

It is the object of the invention as specified in claims 1 and 17 to 21 to provide galvanic elements of a simple design and to produce them in a cost effective manner.

This object is solved by the features set forth in claims 1 and 17 to 21.

The galvanic elements with at least one substrate and two electrodes, as well as at least one electrolyte at least in some areas between the electrodes, and the methods of producing flat galvanic elements are particularly characterized by their simple design and cost efficient manufacture.

For this purpose, at least one area of a plate-shaped body with incorporated openings is placed between the electrodes as a separator. Instead, at least one area of an object as a container or a shell can be arranged between the electrodes, partial areas of the substrate or also one of the electrodes as well as a partial area of the substrate. Thus, the galvanic elements essentially consist of two electrodes that are separated by an electron-conducting and ion-conducting solution that serves as an electrolyte. At discharge, the electron current associated with the chemical reaction flows through the consumer connected to the electrodes and performs electric work.

The electrodes themselves consist of one or several layers in the form of a current-discharging part and a chemically active part.

The electrodes can be arranged vertically relative to one another as well as next to each other in one plane in the enclosed galvanic element. The electrodes consist of known materials, such as zinc and manganese (IV) oxide.

The electrodes may also be deposited as separate electrodes. This is in this connection for example a film or a textile as an electrode proper.

The electrolyte is a liquid or a paste. It is either introduced as a compound itself, or is located in at least one container, or in separate balls. The container is e.g. a cushion. The container and the balls are designed so that they can open. In the closed state the container prevents drying out. In this connection, particularly the balls with the electrolyte can be located next to the electrodes, inter alia, so that when bursting open the electrolyte gets between the electrodes. Such a realization is characterized by a particularly flat configuration.

Advantageously, the balls may be deposited in bulk or in continuous form as bubble film directly during the production of the galvanic element. The electrolyte may, for example, be an aqueous solution of zinc chloride. However, it is also possible to apply the electrolyte separately in the form of salt and solvent, so that they mix at the time when the containers or balls burst open, the galvanic elements become active in this way.

Opening of the capsules or the container can be made easier by specifically designed shaped elements. Of course, containers and capsules may also be equipped with predetermined breaking points.

Another advantage may result from stained electrolytes that permit observation of the function of the galvanic elements through transparent areas of the galvanic elements. A pH value indicator may be provided in addition to, or instead of, this feature.

The separator material between the electrodes does not need to be porous or absorbent.

Advantageously, any plastic film can be used for implementing the galvanic elements. Other electrically non-conducting materials such as ceramics, wood, derived timber product, or paper may also be used as a separator material.

Another advantage is that the internal resistance of the battery is reduced by the openings in the separator.

In addition, wetting of the electrodes with electrolyte and forming the battery is improved as no porous material has to be first impregnated. Use of these materials provides a galvanic element completely sealed relative to its exterior.

Especially when using plastic film, it is advantageously possible to use one and the same material as base film or substrate for the electrodes, either individually or in combination, and/or as a separator at the same time. This allows the production of folded or seamed galvanic elements, wherein sections of the galvanic elements are folded, creased, seamed, bent or upset components.

For this purpose, openings are incorporated into at least one area of a plate-shaped body as, used as a separator. This is done e.g. by irradiation with laser beams, stamping, thermal hole punching, punching, embossing, rolling, electric perforation, electric puncturing, plasma etching, ion irradiation or wet-chemical etching. The separator and/or the substrate with electrodes arranged thereon are provided with an electrolyte. The electrodes point toward the separator or toward one another.

In a first variant, at least one layer is applied at least as an electrode, respectively, onto a first area and a second area of an elongate web-like flexible body used as substrate. One of the electrodes with the plate-shaped body as a separator is provided with the electrolyte. The substrates with the electrodes are folded, creased, seamed, bent, or upset such that the electrodes point toward the separator and electrolyte.

In a second variant, openings are incorporated into a first area n of an elongate web-like, flexible body used as a separator and at least one layer is deposited at least as an electrode onto a second area used as a substrate. The first area is the separator or a separator with electrolyte. This first area and the second area as substrate with the electrode with electrolyte or the electrode are folded, creased, seamed, bent, or upset. Another substrate with a layer, used at least as an electrode, is applied to these areas in such a way that the electrodes point toward the separator and electrolyte.

In a third variant, the electrodes are applied, each in a longitudinal direction, onto a first area of an elongate, web-like body and onto a third area on the opposite side of the elongate body. Openings are incorporated into a second area between the first and third sections as separator. An electrolyte is applied onto at least one area, and the first and third sections, respectively, are folded, creased, seamed, bent, or upset onto the second section in such a way that the respective layer used as an electrode points toward the second area.

In a fourth variant, layers are deposited in a longitudinal direction at a spacing relative to one another onto a first and an adjacent second section of an elongate web-like body to serve at least as the electrodes. Openings are incorporated as separators in a third section, following the first and second sections. An electrolyte is deposited onto at least one area. The third area, used as a separator, is folded onto the second area and the first section is folded, creased, seamed, bent, or upset onto the second area as a separator, so that the respective layer as an electrode points toward the third area used as a separator.

The elongate body, formed in accordance with these variants, is split transversely to its longitudinal direction into sections that form galvanic elements, and the sections are closed at their cutting edges using joining techniques.

This allows a highly cost efficient production that is suitable for mass production. Very cost efficient galvanic elements can be produced.

Advantageous embodiments of the invention are described in claims 2 to 16, 22 and 23.

According to the improvement described in claim 2, the separator comprises the openings as well as at least one void as a container with electrolyte that is to be opened or that opens. In this way the electric work is performed only once container has opened. The function of the galvanic element begins only at the time of opening of the container.

According to the embodiment of claim 3, this is either an area of the container that is to be opened by the effect of a force that results form at least one physical effect or an area of the container that is to be opened by the action of at least one substance by means of a physical and/or chemical effect.

The action of the substance advantageously may cause the at least one area of the container to dissolve. This can be done advantageously by a chemical reaction that determines the time of opening of the container. Moreover, this can be realized by a different chemical reaction wherein the container by means of the action of a physical effect resulting therefrom opens or is opened. This can be e.g. realized by pressure increase in the interior of the container so that the container will burst. This can also be achieved by rated breakpoints of the container.

The separator according to the embodiment of claim 4 has openings as well as at least one void as a container for electrolyte wherein this is advantageously a void to be opened by the action of a mechanical force and the resulting increased pressure.

The void can be opened by the action of a mechanical pressure, wherein the separator will open or can be punctured with suitable means so that the electrolyte can reach the electrodes.

In this way the galvanic element functions only after a mechanical force has been applied. The electric work is performed only after this point in time.

The area of the object according to the embodiment of claim 5 is a layer that is present either permanently or temporarily wherein in case of permanent presence the layer is preferably electron-permeable and/or ion-permeable and wherein in the temporary case the layer is at least partially removable by action of at least one substance or a force resulting from a physical effect.

According to the embodiment of claim 6, the electrolyte is limited by at least one frame with an adhesive and/or bridging segment, thus implementing one or multiple galvanic elements. This allows switching multiple galvanic elements in series or in parallel. The frame or bridging segment itself or a part thereof may simultaneously serve as a current-discharging part. This is inter alia an electrode that is self-adhesive on one or both sides, and conductive in at least one direction of orientation.

According to the embodiment of claim 7, a part of a flexible body is a substrate for an electrode and a further part of the flexible body is either a plate-shaped body or a further support for an electrode. In addition, the parts are folded, creased, seamed, bent or upset components of the galvanic element. In this way, a very simple and cost-effective realization of galvanic elements is possible. They can be embodied e.g. as flat galvanic elements.

According to the embodiment of claim 8, the plate-shaped body and the substrates for the electrodes are preferably a flexible body. Moreover, sequentially a first area forms the first substrate, a second area forms the separator, and a third area the second substrate. The electrodes are located on opposite sides of the flexible body and the first area and the second area with the electrode are folded, creased, seamed, bent or upset in the direction of the second area as separator filled with electrolyte so that they point in the direction of the separator. In this way, a very simple realization of galvanic elements is possible.

According to the embodiment of claim 9, in the folded, creased, seamed, bent or upset state the first area with the electrode and the third area with the electrode each project past the second area as separator with the electrolyte so that one area each of the electrode is not covered. This enables easy contacting of the galvanic elements.

According to the embodiment of claim 10, the substrates for the electrodes are advantageously a flexible body wherein sequentially a first area is the first substrate and a second area is the second substrate of the flexible body, respectively. The electrodes are located on one side of the flexible body. The plate-shaped body as a separator and the electrolyte between the folded, creased, seamed, bent or upset substrates are arranged such that the electrodes each point in the direction of the separator and the electrolyte.

According to the embodiment of claim 11, it is preferred that a substrate with an electrode and the plate-shaped body are one flexible body. Sequentially, a first area is the first substrate and a second area is the separator, both being part of the flexible body. Another substrate with the electrode is located on the folded, creased, seamed, bent or upset plate-shaped body with the electrode and the separator with the electrolyte, so that the electrodes each point toward the separator and the electrolyte.

The plate-shaped body and the substrates for the electrodes are one flexible body according to the embodiment of claim 12. One after the other, a first area forms the first substrate, a second area the second substrate, and a third area the separator. The electrodes are located on one side of the flexible body. In addition, the third area as separator is folded, creased, seamed, bent or upset toward the second area with the electrode and the first area is folded, creased, seamed, bent or upset toward the second area with the electrode, the separator, and the, electrolyte. This makes the electrodes point toward the separator. This is a very simple realization of the galvanic elements that can be produced at high cost efficiency.

According to the embodiment of claim 13, the flexible body between the electrodes comprises at least one cutout, so that a portion of the electrode of the second area is not covered in the folded, creased, seamed, bent or upset condition. In addition, the first area with the electrode projects past the folded, creased, seamed, bent or upset third section, so that a portion of this electrode is not covered. This facilitates easy contacting of the galvanic elements.

The flexible body, according to the embodiment of claim 14, is part of an elongate web-like body and the areas are arranged next to each other in the transverse direction to the longitudinal axis of the web-like body so that a section of the web-like body separated in the transverse direction to the longitudinal axis is a flat galvanic element when in a folded, creased, seamed, bent or upset state. This enables mass production of the galvanic elements. It is preferred that the flexible body is on rolls to enable easy handling during and after realization the galvanic elements.

According to the embodiment of claim 15, at least one other area of the plate-shaped body that does not form the separator is the component carrier. This allows the realization of compact active electronic modules.

In the embodiment of claim 16, in the area of the plate-shaped body with integrated openings as a separator there is a frame of the same shape, respectively, on both sides either with or without at least one bridging segment so that one or several voids for the electrolyte are formed together with the substrates with the electrodes. This, on the one hand, ensures an even and flat structure of the galvanic elements. On the other hand, in case of several voids the galvanic elements formed in this way may also become active successively.

According to the embodiment of claim 22, the layer is deposited at least as an electrode either as a continuous track or partially. In the latter case, the length of this layer in, longitudinal direction of the elongate body determines the width of the galvanic element.

Favorable materials for the elongate, web-like body, according to the embodiment of claim 23, are plastic, paper, or textile.

Embodiments of the invention are shown in principle in the figures and will be explained in greater detail below.

It is shown in

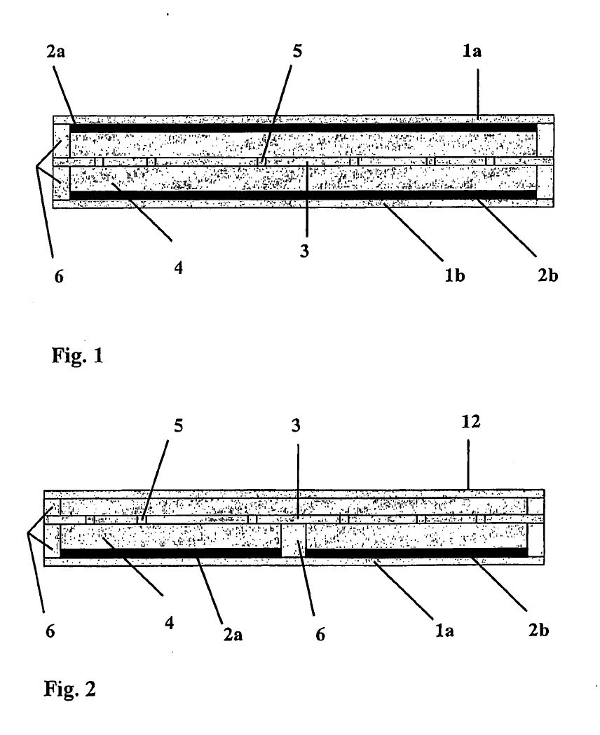

FIG. 1 a galvanic element,

FIG. 2 another galvanic element with electrodes arranged next to each other,

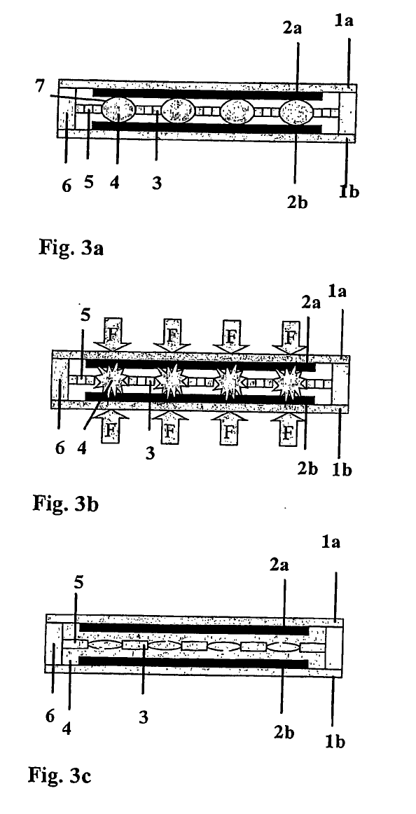

FIG. 3 a galvanic element with voids for the electrolyte,

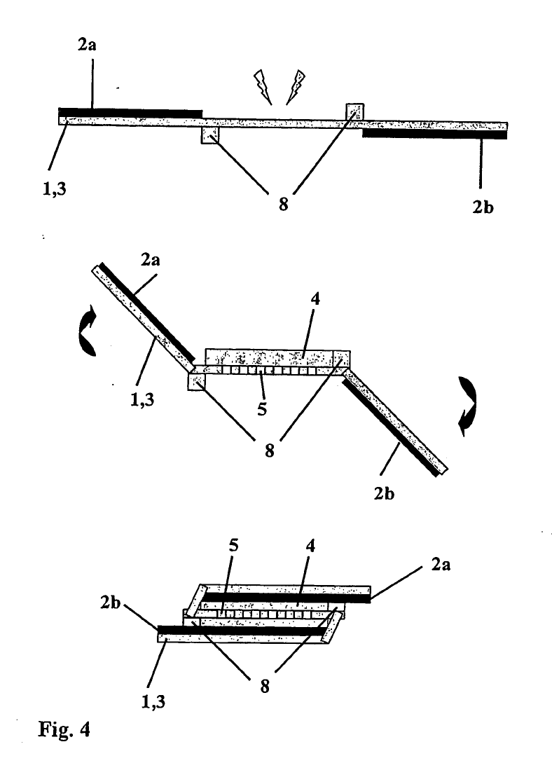

FIG. 4 a galvanic element formed by folding, creasing, seaming, bending or upsetting;

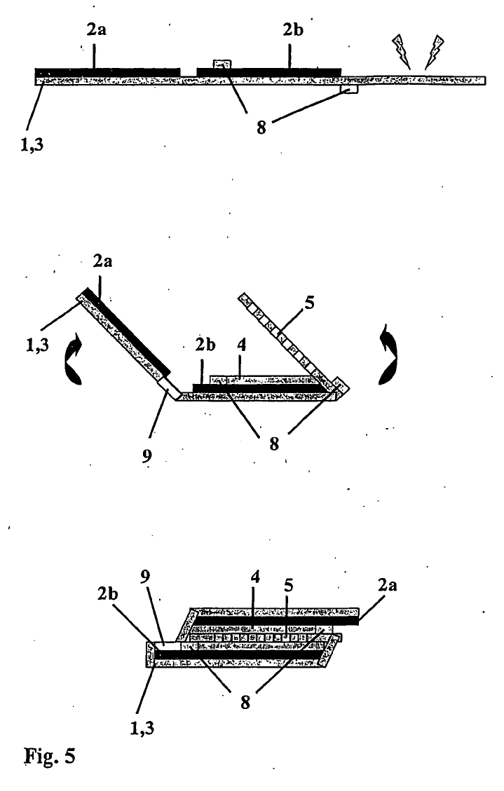

FIG. 5 another galvanic element formed by folding, creasing, seaming, bending or upsetting; and

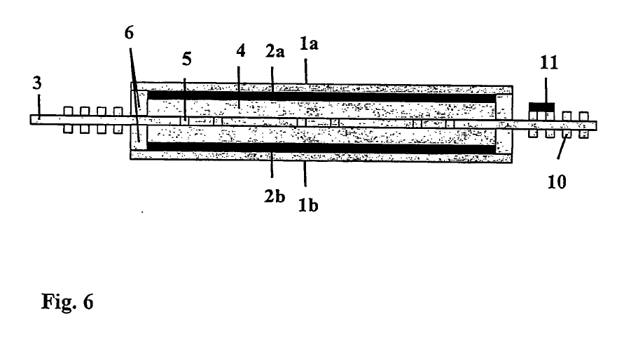

FIG. 6 a module with a galvanic element with a separator that also functions as a component carrier.

The various arrangements of the galvanic elements and methods of their production are explained in detail in connection with the embodiments described below.

### Embodiment 1

A galvanic element generally consists of at least a substrate 1, two electrodes 2a, 2b, a separator 3, and an electrolyte 4.

FIG. 1 shows a schematic diagram of a galvanic element.

In a first variant of the first embodiment, two substrates 1a, 1b are each provided with a layer as an electrode 2a, 2b. It is preferred that the substrates 1a, 1b consist of a plastic material. Paper, a textile, or a ceramic material may be used instead of plastic material. The electrodes 2a, 2b are applied as layers using known application techniques. These include printing, laminating, spraying, depositing, soldering, dosing/dispensing, and vapor depositing, sputtering, or chemical deposition. Moreover, films or textiles may also be applied as electrodes 2a, 2b. A frame 6 is placed along the perimeter of at least one of the substrates 1 on the side of the electrode 1b. A plate-shaped body with incorporated openings 5 is placed as a separator 3 on the substrate 1b with the frame 6. The openings 5 are produced by irradiation with laser beams, hole punching, thermal hole punching, electric perforation or electric puncture. The separator 3 preferably consists of a plastic material. Similar materials may be used as well. These include ceramic materials, paper or a textile. Another frame 6 that corresponds to the frame 6 on the substrate 1a is attached to this separator 3. The void formed in this way is filled with the electrolyte 4. Finally, the second substrate 2b is attached to the frame 6 in such a way that the electrode 1 a points toward the separator 3. This creates an enclosed galvanic element with the following layers: substrate 1b, electrode 2b, electrolyte 4, separator 3, electrolyte 4, electrode 2a, and substrate 1a. The enclosure is ensured by the frame 6 that retains the electrolyte 4. Known bonding methods, e.g. gluing technologies, are used to fasten the frame and thus the components of the galvanic element.

Overlaps may result in outward protrusion of end sections of the electrodes 2a, 2b past the frame to enable easy contacting of the galvanic element.

In another variant of the embodiment, the separator 3 may have voids 7 filled with electrolyte 4 in addition to the incorporated openings 5. The separator 3 preferably consists of a plastic material. The voids 7 are bubbles generated in the plastic material. The remaining structure corresponds to that of the first variant, however, the electrolyte 4 is not introduced separately, but is located in the voids 7.

FIG. 3a shows a galvanic element with voids 7 for the electrolyte 4 in a schematic diagram.

The walls of the voids 7 are designed in such a way that they can be destroyed when a mechanical pressure (F) acts on the galvanic element, causing the existing bubbles to burst (as shown in FIG. 3b). In this way the electrolyte 4 reaches the electrodes 2a, 2b (as shown in FIG. 3c).

In a second variant of the first embodiment, at least the electrodes 2a, 2b are applied at a spacing to each other to the substrate 1 and arranged thereat. The separator 3 that corresponds to the first variant is attached by bridging segments 8 over one of the electrodes 2a, 2b at a spacing thereto. The electrolyte 4 is deposited either directly or in at least one container on top of this arrangement. The electrolyte 4, the electrodes 2a, 2b, and the separator 3 are enclosed by a cover 12. The result is a galvanic element with electrodes 2a, 2b deposited next to each other on a substrate 1. FIG. 2 shows a schematic diagram of a galvanic element embodied in this way.

### Embodiment 2

A galvanic element essentially consists of two substrates 1a, 1b, each with an electrode 2a, 2b arranged on it, a separator 3, and an electrolyte 4. The substrates 1a, 1b are a flexible body consisting of a plastic material.

At least one layer as at least one electrode 2a, 2b is applied on a first area and a second area of the flexible body used as the substrate 1a, 1b. One of the electrodes 2a, 2b is provided with the plate-shaped body as a separator 3 either with, or/and, the electrolyte 4. The substrates 1a, 1b with electrodes 2a, 2b are folded so that the electrodes 2a, 2b point toward the separator 3 and electrolyte 4.

In a variant of the second embodiment, the flexible body 1, 3 may be an elongate, web-like body with the areas of the second embodiment. Advantageously, this body 1, 3 is wound onto a roll. After folding, creasing, seaming, bending or upsetting the areas, the elongate body is split in the transverse direction to its longitudinal axis into sections that form galvanic elements. The sections are closed along their cut edges using known joining methods such as gluing or welding.

### Embodiment 3

A galvanic element essentially consists of two substrates 1a, 1b, each with an electrode 2a, 2b arranged on it, a separator 3, and an electrolyte 4. One substrate 1 and the separator 3 are a flexible body consisting of a plastic material.

Openings 5 are incorporated into a first area of the flexible body as a separator 3 and at least one layer is applied as at least one electrode 2 onto a second area. The first area used as separator 3 either with, or and, the electrolyte 4 and the second area used as substrate 1 with the electrode 2 are folded. Another substrate 1 with a layer used at least as electrode 2 is applied to the folded sections so that the electrodes 2a, 2b point toward the separator 3 and electrolyte 4.

In a variant of the third embodiment, the flexible body 1, 3 may be an elongate, web-like body with the areas embodied in accordance with the second embodiment. Advantageously, this body 1, 3 is wound onto a roll. After folding, creasing, seaming, bending or upsetting the areas, the elongate body is split in the transverse direction to its longitudinal axis into sections that form galvanic elements. The sections are closed along their cut edges using known joining methods such as gluing or welding.

### Embodiment 4

A galvanic element essentially consists of two substrates 1a, 1b, each with an electrode 2a, 2b arranged on it, a separator 3, and an electrolyte 4. The substrates 1a, 1b and the separator 3 are

a flexible body consisting of a plastic material.

FIG. 4 shows schematic diagrams of a galvanic element formed by folding, creasing, seaming, bending or upsetting.

At least one layer is applied at least as electrode 2a onto a first area of a body 1, 3, and at least one other layer is applied in longitudinal direction at least as electrode 2b onto a third area on the opposite side of the body 1, 3. Openings 5 are incorporated into a second area between the first and third areas so that a separator 3 is realized.

The electrolyte 4 is applied to at least one area.

The first and third areas are each folded onto the second area so that the respective electrode 2a, 2b points toward the second area used as separator 3.

It is preferred that bridging segments 8 are provided for joining the areas to be folded, creased, seamed, bent or upset onto each other. The connections with these bridging segments 8 are based on known joining methods such as gluing.

In one variant, the first area with the electrode 2a and the third area with electrode 2b may each project past the second area as separator 3 with the electrolyte 4 in the folded, creased, seamed, bent or upset state so that the end portions of the electrodes 2a, 2b are not covered.

In another variant of the embodiment, the flexible body 1, 3 may be an elongate, web-like body with the areas embodied according to the second embodiment. Advantageously the body 1, 3 is wound onto a roll. After folding, creasing, seaming, bending or upsetting. the areas, the elongate body is split in the transverse direction to its longitudinal axis into sections that form galvanic elements. The sections are closed along their cut edges using known joining methods such as gluing or welding.

### Embodiment 5

A galvanic element essentially consists of two substrates 1a, 1b, each with an electrode 2a, 2b arranged on it, a separator 3, and an electrolyte 4. The substrates 1a, 1b and the separator 3 are a flexible body consisting of a plastic material.

FIG. 5 shows schematic diagrams of a galvanic element formed by folding, creasing, seaming, bending or upsetting.

At least one film is applied at least as electrode 2a, 2b onto a first area and an adjacent second area of the body 1, 3, respectively. Openings 5 are incorporated as separator 3 in a third area between the first and second areas.

An electrolyte 4 is applied onto at least one area.

The third area used as separator 3 is folded onto the second area and the first area is folded onto the second area section as separator 3 in such a way that the respective electrode 2a, 2b points toward the third area used as separator 3.

It is preferred that bridging segments 8 are provided for joining the areas to be folded, creased, seamed, bent or upset onto each other. The connections with these bridging segments 8 are based on known joining methods, such as gluing.

In one variant of the embodiment, the flexible body 1, 3 may comprise at least one cutout 9 between the electrodes 2a, 2b so that a portion of the electrode 2b of the second area is not covered in a folded, creased, seamed, bent or upset condition. In addition, the first area with the electrode 2a projects past the folded, creased, seamed, bent or upset third area, so that an end portion of this electrode 2a is not covered.

In another variant of the fifth embodiment, the flexible body 1, 3 is an elongate web-like body with the areas embodied according to the third embodiment. Advantageously, this body 1, 3 is wound onto a roll. After folding, creasing, seaming, bending or upsetting the areas, the elongate body is split in the transverse direction to its longitudinal axis into sections that form galvanic elements. The sections are closed along their cut edges using known joining methods, such as gluing or welding.

### Embodiment 6

A module with a galvanic element essentially consists of a galvanic element according to the first embodiment. The plate-shaped body used as separator 3 however projects past the galvanic element.

FIG. 6 shows a schematic diagram of a module with a galvanic element with a separator 3 that also functions as a component carrier.

The at least one portion of the plate-shaped body that projects past the galvanic element simultaneously functions as a component carrier. Conductors 10 are deposited using known additive techniques or produced using known subtractive techniques. At least one electronic component 11 is located on the conductors 10 formed as contacts. Known layering and joining methods are used for fastening and electrically contacting the component 11.

What is claimed is:

1.-23. (canceled)

24. A flat galvanic element with at least one substrate and two electrodes as well as at least one electrolyte at least in sections between the electrodes, wherein at least one section of a plate-shaped body with incorporated openings is arranged as a separator between the electrodes.

25. The flat galvanic element according to claim 24, wherein the openings incorporated into the plate-shaped body by irradiation with laser beams, punching, thermal punching, electroperforation, or electric puncture are used as separator.

26. The flat galvanic element according to claim 25, wherein the separator comprises both the openings and at least one void with the electrolyte, wherein the void can be opened by mechanical pressure.

27. The flat galvanic element according to claim 24, wherein the electrolyte is retained by at least one frame and/or bridging segment with an adhesive so that one galvanic element or several galvanic elements are formed, the frame and/or the bridging segment are a separate part or a component of the electrode.

28. The flat galvanic element according to claim 24, wherein the plate-shaped body and the substrates for the electrodes are a flexible body, wherein, sequentially, a first area is the first substrate, a second area is the separator, and a third area is the second substrate of the flexible body; wherein the electrodes are located on opposite sides of the flexible body; and wherein the first area with the electrode and the third area with the electrode are each folded toward the second area used as the separator with the electrolyte so that the electrodes point toward the separator.

29. The flat galvanic element according to claim 28, wherein, in folded condition, the first area with the electrode and the third area with the electrode each project past the second section used as the separator with the electrolyte so that a portion of the electrodes is not covered.

30. The flat galvanic element according to claim 24, wherein the substrates for the electrodes are a flexible body, wherein, sequentially a first area is the first substrate and a second area is the second substrate, respectively, of the flexible body, the electrodes being located on one side of the flexible body, and wherein the plate-shaped body used as separator and the electrolyte are placed between the folded substrates so that the electrodes each point toward the separator and the electrolyte.

31. The flat galvanic element according to claim 24, wherein a substrate with an electrode and the plate-shaped body are a flexible body, wherein, sequentially, a first area is the first substrate and a second area is the separator, respectively, of the flexible body, and wherein another substrate with the electrode on the folded plate-shaped body with the electrode and the separator with the electrolyte are arranged such that the electrodes each point toward the separator and the electrolyte.

32. The flat galvanic element according to claim 24, wherein the plate-shaped body and the substrates for the electrodes are a flexible body, wherein, sequentially, a first area is the first substrate, a second area is the second substrate and a third area is the separator, respectively, of the flexible body, wherein the electrodes are located on one side of the flexible body, and wherein the third area as separator is folded toward the second area with the electrode and the first area is folded toward the second area with the electrode), the separator, and the electrolyte.

33. The flat galvanic element according to claim 30, wherein the flexible body comprises at least one cutout between the electrodes so that in folded condition a portion of the electrode of the second area is not covered and that the first area with the electrode projects past the third area so that a portion of the electrode is not covered.

34. The flat galvanic element according to claim 30, wherein the flexible body is part of an elongate web-shaped body, the areas being arranged next to each other in longitudinal direction of the web-shaped body so that a section of the web-shaped body cut transversely to the longitudinal direction of the web-shaped body, is either a component of a flat galvanic element or is itself a flat galvanic element.

35. The flat galvanic element according to claim 24, wherein at least one other area of the plate-shaped body not forming the separator is a component carrier so that an electronic module with at least one galvanic element is formed.

36. The flat galvanic element according to claim 24, wherein a frame of same configuration, with or without at least one bridging segment, is located on both sides on the area of the plate-shaped body with the incorporated openings as the separator, so that one or several voids for the electrolyte are formed together with the substrates with the electrodes.

37. The flat galvanic element according to claim 34, wherein the elongate web-shaped body consists of a plastic material, paper, or a textile.

39. A method of producing flat galvanic elements according to claim 24, wherein openings are incorporated into at least one area of a plate-shaped body used as separator, wherein the separator is provided with an electrolyte and the substrates are provided with the electrodes in such a way that the electrodes point toward the separator with the electrolyte.

39. A method of producing flat galvanic elements according to claim 24, wherein at least one layer to be used as electrode is applied to a first area a second area of an elongate web-shaped flexible body used as substrate; wherein one of the electrodes is provided with the plate-shaped body as separator with or without the electrolyte, wherein the substrates with the electrodes are folded so that the electrodes point toward the separator and the electrolyte; wherein the elongate body formed in this way is split transversely to a longitudinal direction into sections forming galvanic elements; and
wherein the cut edges of the sections are closed by joining.

40. A method of producing flat galvanic elements according to claim 24, wherein openings are incorporated into a first area of an oblong, web-shaped flexible body used as separator and at least one layer is applied as at least one electrode on a second area used as substrate; wherein the first area used as separator with or without the electrolyte and the second area used as substrate with electrode are folded, wherein another substrate with a layer at least as electrode is deposited onto the folded areas so that the electrodes point toward the separator and the electrolyte; and wherein the elongate body formed in this way is split transversely to its longitudinal direction into sections forming galvanic elements, and wherein the cut edges of the sections are closed by joining.

41. A method of producing flat galvanic elements according to claim 24, wherein at least one layer is applied as electrode in longitudinal direction onto a first area of an elongate, web-shaped flexible body and wherein at least one layer is applied as at least an electrode in a longitudinal direction onto a third area on the opposite side of the elongate web-shaped flexible body; wherein openings are incorporated as separator into a second area between the first and third areas; wherein the first area and the third area each are folded onto the second area used as separator either with or without the electrolyte so that the respective layer used as electrode points toward the second area;
wherein the elongate body thus formed is split transversely to its longitudinal direction into sections forming galvanic elements; and wherein the cut edges of the sections are closed by joining.

42. A method of producing flat galvanic elements according to claim 24, wherein at least one layer each is applied as at least an electrode in longitudinal direction at a spacing relative to one another onto a first area and an adjacent second area of an elongate web-shaped flexible body; wherein openings are incorporated as separator into a third area after the first and second areas; wherein the first area used as separator either with or without the electrolyte is folded onto the second area, and the first area is folded onto the second area in such a way that the respective film used at least as electrode points toward the third area used as separator; wherein the elongate body thus formed is split transversely to its longitudinal direction into sections forming galvanic elements; and
wherein the cut edges of the sections are closed by joining.

43. The method according to claim 39, wherein the layer used as electrode is applied as a continuous track or the layer used as electrode is applied partially so that the length of the layer in longitudinal direction of the elongate body determines a width of the galvanic element.
